(19) United States
(12) Patent Application Publication
(10) Pub. No.: US 2004/0191417 A1
(43) Pub. Date: Sep. 30, 2004

(54) Method of integrating a porous dielectric in an integrated circuit device

(76) Inventors: Dorie Yontz, Midland, MI (US); Jerry Hahnfeld, Midland, MI (US); Brian Landes, Midland, MI (US); Sebring Lucero, Freeland, MI (US); Daniel Castillo, Freeland, MI (US); Kacee B. Ouellette, Midland, MI (US); Theodore M. Stokich JR., Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/402,103

(22) Filed: Mar. 28, 2003

(51) Int. Cl. B05D 3/02; B05D 1/36

(52) U.S. Cl. 427/372.2; 427/402

(57) ABSTRACT

The present invention is a method which provides flexibility and convenience in integration of porous dielectric materials without any substantial sacrifice in quality of the porous dielectric material formed during the process. This method enables one to create multilayer stacks that include embedded porous layers without having to remove the substrate being coated from the spin track between applications of the various layers and without deterioration in pore morphology in the porous layers.

### FIELD OF THE INVENTION

This invention relates to a method of integrating a porous dielectric material in an integrated circuit device.

### BACKGROUND OF THE INVENTION

Various materials and methods have been suggested for making porous dielectric films. See e.g. WO00/31183.

In addition, various approaches have been proposed for integrating porous dielectric materials in the manufacture of integrated circuit devices.

US 2002/74659, for example, teaches that a precursor to a porous dielectric material can be applied, partially cured (preferably at a temperature not higher than 250° C.), patterned, and then fully annealed to complete the cure and remove a volatilizable material leaving voids in the dielectric material. Similarly, US 2002/30297 teaches partial cure and patterning of the dielectric layer prior to removal of the poragen.

US2002/117760 and US 2002/117737 teach the use of buried etch stops which may be spin coated onto the via-level dielectric material. The via-level dielectric is taught to be porous or possibly porous. These publications recognize the need to render the initial spin-coated layers insoluble by at least partial cure prior to application of subsequent spin coated layers.

US2002/117754 teaches the use of two different types of materials for the via and line layer dielectrics. One or more of these materials are taught to be porous and both are taught to be applied by spin coating.

While the latter publications disclose various conceptual approaches to integration, they contain no working examples. When attempts were made to utilize the concepts fundamental to the above integration approaches, it was discovered that pore size and morphology deteriorated significantly.

### SUMMARY OF THE INVENTION

The present invention is a method which provides flexibility and convenience in integration of porous dielectric materials without any substantial sacrifice in quality of the porous dielectric material formed during the process. This method enables one to create multilayer stacks that include embedded porous layers without having to remove the substrate being coated from the spin track between applications of the various layers and without deterioration in pore morphology in the porous layers.

Specifically, this method comprises the steps of:

(a) providing a substrate,

(b) forming a first layer comprising a poragen material dispersed in a matrix precursor material on the substrate,

(c) curing the matrix precursor to form a gelled matrix material,

(d) solvent coating a subsequent layer over the gelled layer, and

(e) removing the poragen material from the first layer after application of the subsequent layer,

wherein the process is characterized in that the matrix material of the first layer does not undergo any substantial decrease in shear modulus prior to removal of the poragen.

Phrased alternatively, this method comprises the steps of:

(a) providing a substrate,

(b) forming a first layer comprising a poragen material dispersed in a matrix precursor material on the substrate,

(c) curing the matrix precursor to form a gelled matrix material,

(d) solvent coating a subsequent layer over the gelled layer, and

(e) removing the poragen material from the first layer after application of the subsequent layer,

wherein the process is characterized in that the average pore size differs from the average poragen size by less than 40%.

A substantial decrease in modulus as used herein is a change in modulus that allows a significant degree of agglomeration of poragens as demonstrated by a marked increase in pore size relative to poragen size. When discussing modulus changes herein, we are referring to changes in the modulus of the matrix precursor/gelled matrix material/cured matrix material as the process set forth above progresses. Preferably, the average pore size is not more than about 40% different from the average poragen size. Preferably, there is no decrease in apparent shear modulus in the matrix material/matrix precursor material greater than 80%. Preferably, the apparent shear modulus does not fall below about 8×10⁶ dynes/cm².

### DETAILED DESCRIPTION OF THE INVENTION

The method of this invention applies to integration of any pore forming compositions that are swellable or solvent dispersible prior to cure and that are thermally curable. The composition comprising matrix precursor and poragen may be applied by any known method such as extrusion coating, knife coating, but is preferably applied by a solvent coating method such as spin coating, ink jet printing, or the like. Non-limiting examples of suitable solvents include mesitylene, methyl benzoate, ethyl benzoate, dibenzylether, diglyme, triglyme, diethylene glycol ether, diethylene glycol methyl ether, dipropylene glycol methyl ether, dipropylene glycol dimethyl ether, propylene glycol methyl ether, dipropylene glycol monomethyl ether acetate, propylene carbonate, diphenyl ether, cyclohexanone, butyrolactone, ethyl ethoxypropionoate and mixtures thereof.

Examples of compositions include organic or inorganic polymer systems having a poragen material dispersed in a matrix material. Examples of suitable matrix materials include benzocyclobutene based resins, such as Cyclotene™ resins from The Dow Chemical Company; polyarylene resins and polyarylene ether resins, such as SiLK™ polyarylene resins from The Dow Chemical Company; silsesquioxanes (e.g., hydrogen silsesquioxanes, methylsilsesquioxanes, etc.) and the like. Preferably, the matrix materials are polyarylene or polyarylene ether based materials that cure or cross-link via Diels Alder reaction (i.e., reaction of a dienophile and a diene, such as reaction of cyclopentadienone functional groups with acetylene functional groups) and/or via acetylene/acetylene reactions. The most preferred matrix materials are those polymers which are formed by reaction of cyclopentadienone and acetylene functional monomers wherein at least some of the monomers have at least three reactive functional groups. See U.S. Pat. No. 5,965,679 and copending U.S. Application 10/078205, both of which are incorporated herein by reference.

The poragen may be any material that forms discrete nanosized (dimensions on the order of 50 nm or less, preferably 20 nm or less, more preferably 10 nm or less) regions in the matrix material and can be subsequently removed to form voids in the matrix material. The poragen may be a small molecule but, preferably, the poragen is a polymeric material that is removed from the matrix material by heating, although other methods such as solvent extraction, radiative methods, supercritical-fluid extraction, etc. may be used as alternatives. Suitable poragens include polystyrene and polyacrylic based materials. Particularly preferred are such materials that have a restricted geometry—e.g. star polymers, dendrimers, and cross-linked nanospheres. Most preferably, the poragens have reactive groups that are used to bind them to the matrix material.

Suitable poragens include polystyrenes such as polystyrene and poly-α-methylstyrene; polyacrylonitriles, polyethylene oxides, polypropylene oxides, polyethylenes, polylactic acids, polysiloxanes, polycaprolactones, polyurethanes, polymethacrylates, polyacrylates, polybutadienes, polyisoprenes, polyamides, polytetrahydrofurans, polyvinyl chlorides, polyacetals, amine-capped alkylene oxides, random or block copolymers of such polymers, and hydrogenated or partially hydrogenated variations of such polymers. The poragens may be linear, branched, hyperbranched, dendritic, or star like in nature. Poragens preferably are characterized in that they form discrete domains in the matrix material. Some materials that are particularly suitable for forming such domains include: hyperbranched polymeric particles, dendrimers, and cross-linked particles as may be made for example by emulsion polymerization. Cross-linked, styrene based polymeric particles (preferably copolymers of styrene and a second monomer having at least two ethylenically unsaturated groups—e.g. divinyl benzene or di-isopropenyl benzene) having particle sizes of less than 30 nm, more preferably less than 20 nm are particularly suitable for use as poragens with the polymers of this invention as the matrix materials. See copending U.S. application Ser. No. 10/366494 having attorney docket number 61599B.

Preferably, the poragen and a curable precursor to the matrix material are combined. While the poragens may be added to the precursor after B-staging (i.e. partial polymerization), it is also possible to add the poragens to the monomers prior to the B-staging reaction. In the latter case, without wishing to be bound by theory, it is believed that the poragens react with the monomers. However, whether a chemical bond is formed or whether other interaction (e.g. formation of interpenetrating network) occur, a graft between the particle and the monomer/oligomer is formed and is detected by SEC analysis. By grafting, it means matrix is either chemically bonded to the poragen or permanently entangled with poragen.

The combination of curable matrix precursor and poragen, preferably in a solvent (as used herein solvent indicates a single solvent or a solvent system containing two or more solvents) is applied to the substrate. Most preferably, the layer comprising matrix precursor and poragen are spin coated from a solvent onto the substrate.

The substrate may be any substrate on which it is desired to form a layer of the very low dielectric constant material. The substrate may include silicon wafers with or without additional layers and components. These additional layers or components may include transistors, metal interconnect lines, dielectric materials, and the like that are typically found in integrated circuit manufacture.

After forming the layer comprising the matrix precursor and the poragen, the layer is cured past its gel point such that neither the layer nor any significant portion of the layer is removed during solvent coating of the subsequent layer. Preferably, the layer is cured sufficiently such that it does not undergo significant swelling during coating of the subsequent layer. Significant swelling is considered an increase in dimensions of the layer when exposed to the solvent used in coating the subsequent layer. Preferably the layer swells by no more than 50% based on initial volume of the layer, more preferably by no more than 20%, and most preferably by no more than 5%.

According to the prior process approaches of which the inventors are aware it was understood that the first layer needed to be partially cured prior to application of the subsequent layer. However, these processes did not take into consideration that both the extent of cure and method of cure needed to be carefully controlled.

Applicants discovered that failure to control both extent of cure and method of cure led to decrease in the modulus of the first layer and this in turn enabled agglomeration of the poragen which ultimately caused larger pore sizes. Surprisingly, this occurred even in systems in which the poragen was grafted (e.g., covalently bonded) to the matrix material. It is critical to the invention that the first layer not undergo a significant decrease in modulus. Thus, the present inventors discovered that both the extent of cure and the method of cure are critical to attaining small pore size.

Preferably, the average pore size is not more than about 40%, more preferably not more than 30%, yet more preferably not more than 20%, and most preferably not more than 10% different from the average poragen size based on initial average poragen size. Average poragen size may be determined by any suitable method but is conveniently determined when using discrete polymeric particles such as cross-linked nanoparticles, star poragens, dendrimers and the like by size-exclusion chromatography with universal calibration and differential viscometric detection (SEC/DV).

The SEC/DV test is performed as follows: A good solvent for the sample and for the standard, preferably polystyrene, is selected. Tetrahydrofuran is a preferred solvent. The column used for the SEC separation contains porous, crosslinked PS particles and the like, and is well suited for separating polystyrene and similar compounds according to size (hydrodynamic volume) in solution. Conventional high pressure liquid chromatography (HPLC) equipment is used for solvent delivery and sample introduction. A differential refractive index detector is used to detect the eluting sample concentration. A differential viscometer is used to detect the specific viscosity of the eluting polymer solution. These detectors are commercially available, for example, under the Model 2410 differential refractive index detector from Waters and model H502 differential viscometer from Viscotek, Inc. Because the concentrations injected on the SEC system are small, the ratio of specific viscosity to concentration at each SEC elution volume increment provides a reasonable estimate of the intrinsic viscosity of the polymer eluting in the particular volume increment.

The SEC/DV test enables determination of the following properties for the sample: absolute molecular weight distribution (and number average, weight average and z-average molecular weights); collapsed and swollen (that is, in solvent) particle size distribution (and peak and weight average diameters); the Mark-Houwink plot (log[η] versus log M, where [η] is the intrinsic viscosity and M is the molecular weight); the volume swell factor (VSF) in the test solvent, and the PS-apparent molecular weight distribution (and molecular weight averages and polydispersity). The universal calibration curve is determined using narrow molecular weight distribution polystyrene (PS) and, more preferably also, narrow molecular weight distribution polyethylene oxide (PEO) standards. The curve is a plot of log([η]*M) versus elution volume. The product of [η]*M is proportional to hydrodynamic volume. Because ideal SEC sorts molecules according to hydrodynamic volume, a single universal calibration curve is obtained independent of polymer composition or architecture. Thus, with knowledge of the universal calibration curve and the intrinsic viscosity at every SEC elution volume increment, the absolute molecular weight of an unknown sample can be calculated at each elution volume increment.

Weight average diameter of the dry collapsed particle, Dw, is calculated as follows:

Absolute M and polymer concentration data at each elution volume increment allow for the calculation of absolute molecular weight averages and distributions. Transforming the absolute molecular weight axis into a particle size axis is performed according to the equation below:

Dw(in nm)=2*[(Mw)*(L⁻¹)*(density⁽⁻¹⁾)*(10²¹)*0.75*(π⁻¹)]^{1/3}

where Mw is the absolute weight average molecular weight in g/mol, L is Avogadro's number, density is the density of the dry polymer in g/cm³, 10²¹ is a factor to convert cm³ to nm³, and a spherical shape is assumed (V=4/3 πr³). The factor 2 converts r (radius) to Dw (weight average diameter).

The average pore size may be determined by any suitable method such as transmission electron microscopy, but a preferred method is small angle x-ray scattering (SAXS).

Since the methods of determining average pore size and average poragen size are unavoidably different, there may be some unavoidable variation in these values even if there is little or no actual poragen agglomeration and pore growth occurring as the films are processed. Thus, an alternative approach to determining average pore size relative to average poragen size is to use as the average poragen size the average pore size obtained when that composition was processed under ideal conditions for pore generation. The ideal conditions for pore generation would be gradual heating of the poragen containing film after coating, to a temperature sufficient to cure the matrix and remove the poragen.

Preferably, there is no decrease in apparent shear modulus of the matrix greater than 80%, more preferably 50%, more preferably still 30%, yet more preferably 20%, and most preferably 10% based on initial shear modulus.

The apparent shear modulus for the matrix material may be determined by any suitable method for measurement of modulus. Preferably, a solid sample of the matrix precursor material is used in dynamic mechanical spectroscopy (DMS) in parallel plate geometry at a low strain amplitude of 1% and an oscillation frequency of 1 rad/s. The temperature is raised as quickly as possible (preferably at, a rate of at least about 200° C./minute) to determine changes in modulus as the material goes through cure and any other thermal transitions (e.g. glass transition points).

An alternative method of evaluating modulus method is to use torsional impregnated cloth analysis (TICA). In this technique a woven glass cloth (preferably, 0.3 mm thick, 15 mm wide, and 35 mm long) is mounted in a dynamic mechanical analyzer, such as a DuPont 983 DMA, preferably fitted with a Low Mass Vertical Clamp Accessory or equivalent functionality to enhance sensitivity. The ends of the cloth are wrapped in aluminum foil leaving 10 mm in length exposed. The cloth is then mounted in the vertical clamps of the dynamic mechanical analyzer which were set 10 mm apart. The clamps are tightened to about 12 inch pounds using a torque wrench. The cloth is impregnated using a solution comprising the precursor compounds at 10 to 30 percent solids via a pipet. The cloth is thoroughly soaked with the solution and any excess is removed using the pipet. A heat deflector and oven are attached and a nitrogen flow of about 3 standard cubic feet per hour is established. Amplitude of the displacement is set to 1.00 mm and frequency is set to 1 Hz. The sample is heated to 500° C. at 5° C. per minute and then allowed to cool. Data is collected during both the heating and cooling stages. Data analysis may be performed to obtain temperature versus flexural modulus values for the composite of glass and formulation. Prepared software programs such as DMA Standard Data Analysis Version 4.2 from DuPont or Universal Analysis for Windows 95/98/NT Version 2.5H from TA Instruments, Inc., may be used to perform the data analysis. The modulus values themselves are not absolute values for the tested formulation due to the contribution of the glass cloth and the unavoidable variation in sample loading. However, the method gives relative modulus values. Preferably, the apparent shear modulus as measured for example by DMS does not fall below 4×10⁶ dynes/cm², more preferably not below 8×10⁶ dynes/cm², and most preferably not below 1×10⁷ dynes/cm².

Preferably, for manufacturing efficiency, the time required for cure is minimized and the article is not removed from the apparatus (e.g. spin track) between application of the various layers. Thus, while a variety of tools may be used for curing the article (e.g. oven, hot plate, exposure to heat lamps, etc.), using a hot plate for cure is a preferred method for performing the curing step. Hot plate bake steps will generally last for about 30 seconds to about 5 minutes. Methods that would heat the coated substrate in a similar manner to hotplates (i.e. time for sample to reach temperature) are considered equivalents for purposes of the multi-step heating approach. If desired, an initial relatively low temperature (e.g. less than 200° C., preferably not more than about 150° C.) heating step may be used simply to drive off solvent. This heating step would not advance or would not significantly advance cure of the matrix.

The initial curing temperature for hot plate cure, preferably, is selected to be not more than 50° C. above, more preferably not more than 30° C. above, more preferably still not more than 15° C. above, and most preferably not more than 10° C. above the glass transition temperature of the matrix precursor. If the initial cure temperature is too far in excess of the glass transition temperature, a decrease in modulus in the first layer will occur and agglomeration will occur. The initial cure temperature is preferably no less than 75° C. below, more preferably no less than 50° C., and most preferably no less than 20° C. below the glass transition temperature of the matrix precursor. If the initial cure temperature is too low, the cure step will not sufficiently advance the material toward cure. The initial curing time should be sufficient to advance cure and raise the glass transition temperature. Preferably, the glass transition temperature is raised such that it is greater than or equal to 10° C. below the cure temperature, and more preferably is greater than the initial cure temperature. If that degree of cure is sufficient to enable coating of subsequent layers without undue swelling of the first layer and if the article is not going to be subjected to subsequent heat treatments characterized by rapid increases in temperature to temperatures significantly above the cure temperature such as would cause a decrease in modulus of the first layer, the curing step may be completed at that time.

If the layer remains too susceptible to swelling or removal in the solvent used to coat the next layer, one or more subsequent heating step at a final hotplate cure temperature greater than the initial cure temperature will be required. The final hotplate cure temperature is selected such that it is sufficient to cure the matrix past its gellation point for the solvent used to cure the next layer. The final hotplate cure step may occur at temperatures of up to 150° C. above the initial cure temperature.

Preferably, however, to minimize poragen agglomeration and an increase in pore size, a cure temperature used as a second step after the initial step is less than the greater of (a) 50° C., more preferably 30° C., above the original glass transition temperature of the matrix precursor or (b) 40° C., more preferably 35° C., more preferably still 30° C., and most preferably 25° C., higher than the initial cure temperature. Additional heating steps to higher temperatures at similarly increased temperature intervals relative to the immediately preceding cure temperature may be used as needed to get the layer to the desired level of solvent resistance (i.e. low swelling) and or to precondition the layer to subsequent rapid heating steps to which the article may be exposed. If time is less critical, a ramp up (i.e. gradual increase) in cure temperature can be used in place of multiple incremental heating steps.

For the preferred polyarylene matrix materials where cure occurs via Diels Alder (e.g. reaction of cyclopentadienone groups with acetylene groups) and/or by acetylene/acetylene reaction, two or more bake steps (on hot plate) are preferred. The preferred initial hot plate temperature is greater than about 200° C., more preferably greater than about 240° C., yet more preferably greater than 250° C., and most preferably greater than 255° C. The preferred initial hot plate temperature is less than about 280° C., more preferably less than 270° C., and most preferably less than 265° C. The final hotplate cure temperature is preferably greater than 280° C., more preferably greater than 285° C. to achieve the desired degree of solvent resistance. The final hotplate cure temperature is preferably less than about 420° C., more preferably no greater than about 405° C., more preferably still less than 350° C., and most preferably not more than 300° C. If a high (about 320 to 420° C.) final hotplate cure temperature is used, one or more intermediate hotplate bake steps at a temperature in the range of about 270 to about 300° C., preferably about 270 to 280 is recommended. Suitable cure times for incremental hot plate cure steps are from about 30 seconds to about 5 minutes, preferably about 1-2 minutes.

After the cure step, the next layer is solvent coated over the prior layer. The precise identity of this subsequent layer is not critical to this invention. The subsequent layer may be an additional dielectric material of the same or different composition of the first layer. If a different composition is used, it may be the same or similar to the matrix precursor without inclusion of a poragen. Examples of such materials include benzocyclobutene based resins, such as Cyclotene™ resins from The Dow Chemical Company; polyarylene resins and polyarylene ether resins, such as SiLK™ polyarylene resins from The Dow Chemical Company; silsesquioxanes (e.g. hydrogen silsesquioxanes, methylsilsesquioxanes, etc.) and the like. Preferably, the matrix materials are polyarylene or polyarylene ether based materials that cure or cross-link via Diels Alder reaction (i.e.reaction of a dienophile and a diene, such as reaction of cyclopentadienone functional groups with acetylene functional groups) and/or via acetylene/acetylene reactions. The most preferred matrix materials are those polymers which are formed by reaction of cyclopentadienone and acetylene functional monomers wherein at least some of the monomers have at least three reactive functional groups

Alternatively, the subsequent layer may be of a substantially different chemical composition such that it has different etch properties that can be useful in patterning the materials. Thus, if the first layer comprises the preferred polyarylene or polyarylene ether materials, the subsequent layer may advantageously be a silicon based material such as a silsesquioxane or the organosilicate materials which are partially hydrolyzed reaction products of alkoxy or acyloxy silanes as disclosed for example in US Application 2002/0052125. Other solvent coatable materials which may be useful as the subsequent layer includes the following commercially available materials: HOSP or HOSP BESt organosilicates, and Nanoglass E inorganic dielectric films all from Honeywell International Inc., LKD low dielectric constant materials from JSR Corp., Zirkon LK low dielectric constant materials from Shipley Co., L.L.C., ALLCAP from Asahi Chemical, and Ensemble ES and Ensemble CS dielectric solutions from The Dow Chemical Company.

As yet another alternative, the subsequent layer may be a solvent coated photoresist layer that is ultimately removed from the article. The subsequent layer is applied from solvents. Non-limiting examples of solvents which may be used to coat the subsequent layer include mesitylene, methyl benzoate, ethyl benzoate, dibenzylether, diglyme, triglyme, diethylene glycol ether, diethylene glycol methyl ether, dipropylene glycol methyl ether, dipropylene glycol dimethyl ether, propylene glycol methyl ether, dipropylene glycol monomethyl ether acetate, propylene carbonate, diphenyl ether, cyclohexanone, butyrolactone, ethyl 3-ethoxypropionate, N-methylpyrrolidinone, dimethylformamide, dimethylacetamide, tetrahydrofuran, dimethylpropylene urea, butyl acetate, methyl isobutyl ketone, cyclopentanone and mixtures thereof.

The subsequent layer is cured and other integration steps such as etching, metal deposition, chemical-mechanical planarization, cleaning steps, and the like may also be performed.

After application of the subsequent layer and either before or after performing other integration steps, the article is subjected to a heating step in which the poragen decomposes and/or volatilizes and is removed from the article. At some point during the processing, the matrix material is further cured to a degree that the matrix material will be resistant to reflow and the like during subsequent processing. This cure may occur prior to or after removal of the poragen, but is most conveniently allowed to occur simultaneously with removal of poragen via heating. Since the matrix material may not be fully cured in all instances and thus may still in some instances demonstrate a decrease in modulus, it is important to use either a gradual increase in temperature or a step wise increase in temperature for poragen burnout unless the first layer has already been preconditioned as discussed above or is already cured past its vitrification point. This step is conveniently performed in an oven and may be performed on multiple articles simultaneously. In that instance, the articles are placed in the oven and the temperature is increased until the temperature needed for removal of the poragen is reached. The poragen removal temperature is preferably in the range of 300 to 500° C. and the heating step typically takes from 10 minutes to 4 hours.

Additional steps such as applying additional pre-porous layers may occur either before or after the step in which the poragen is removed.

### Examples

All small angle x-ray scattering (SAXS) experiments may be performed using a standard Advanced Photon Source (APS) x-ray source. A monochromatic beam passes through a vacuum chamber which houses a series (3 sets) of slits to define a rectangular shaped beam of known size. The beam then exits the vacuum chamber and passes through air followed by a helium filled chamber prior to entering the path to the sample again in a vacuum sample chamber. An additional pinhole is added approximately 10 cm before the sample position. This collimator is used to block any of the parasitic background rays caused by leakage around the outside limits of the optical components further up the beamline.

The SAXS experiments are performed on double polished silicon wafers (˜100-700 μm thick) coated with ˜0.1-1 μm thick sample. A normal beam transmission mode geometry is employed. The x-ray energy is set between 15-18 keV. Data collection times are set at 10 minutes. A charge coupled device (CCD) detector is used to collect the x-ray scattering from the sample. A separate background file is collected and subtracted from all of the sample data sets. Corrected data is reduced to a one dimensional data set (intensity versus scattering vector, q, where q=4πsinσ/λ; θ=half of the angle of scattering, 2θ; λ=wavelength of radiation) by radially integrating the two dimensional data set. The reduced data set is used to determine the pore size distribution and average pore diameter.

Two different methods are used to generate the average pore size and pore size distribution from the corrected scattering data—Indirect Fourier transformation method for concentrated systems developed by Glatter et al. (see Brunner-Popela, J. and Glatter, O., J. Applied Cryst., (1997) 30,431-442 or Weyerich, B., Brunner-Popela, J., Glatter, O. J. Applied Cryst., (1999), 32, 197-209) and the local monodisperse approximation developed by Pederson (see Pederson, J. S. J. Appl. Cryst. 27, 595, (1994)).

### Example #1

### Preparation of Dispersion of Matrix Precursor and Poragen in Solvent

A composition useful in making porous dielectric films can be prepared by partially polymerizing (i.e. B-staging) the following monomer:

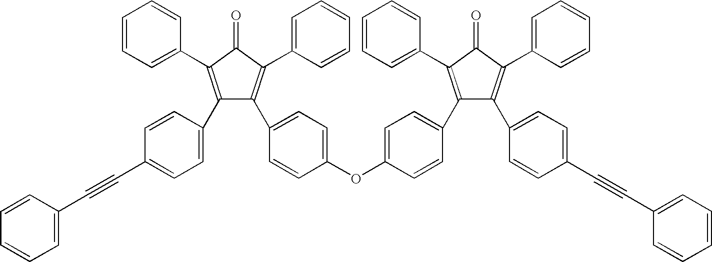

in the presence 30% by weight (based on weight of poragen and monomer) of a cross-linked nanoparticle of styrene/di-isopropenylbenzene copolymer (having an average diameter as determined by SEC/DV of 11 nm) in gamma butyrolactone. The composition was then diluted to 12.3% solids with ethyl 3-ethoxypropionoate.

### Example 2

Compositions made by processes similar to that set forth in Example 1 were spin coated onto silicon wafers. The films were heated on a nitrogen-purged hotplate at a first bake temperature for 90 seconds and then removed. Additional hotplate bakes, where specified, were done for 90 seconds each as well. After the hotplate bake sequence, the wafer was ramped in a nitrogen-purged oven at 8° C./min. to 400° C. and held for 2 hours. The average pore size measured by SAXS as described above is reported in Table 1. Relative degree of agglomeration was evaluated by two Methods. The first method (Method 1) compared the average pore size for the sample as determined by SAXS to the pore size for the control, in which cure occurred during the gradual ramp and over bake. The second method (Method 2) compared average pore size to average poragen size of 11 nm.

TABLE 1

| | | Additional | | | |
|---|---|---|---|---|---|
| | First | bake | Pore | Relative | Relative |
| Example | Bake | temperature | size | Pore Size | Pore Size |
| ID | temp.(° C.) | (s) (° C.) | (nm) | Method 1 | Method 2 |
| Control | 150* | NA | 8.7 | NA | −18% |
| A | 400 | NA | 19.1 | 120% | 73% |
| B | 275 | NA | 13.1 | 51% | 18% |
| C | 260 | NA | 11.5 | 32% | 0% |
| D | 260 | 400 | 12.1 | 39% | 9% |
| E | 250 | NA | 10.7 | 23% | 0% |
| F | 250 | 400 | 12.3 | 41% | 9% |
| G | 250 | 275/400 | 9.8 | 13% | −11% |
| H | 250 | 285 | 10.8 | 24% | 0% |
| I | 285 | NA | 15.8 | 82% | 43% |

*This bake effects solvent removal but no quantifiable advancement of cure.

Solvent resistance was tested by measuring film thickness and uniformity on samples of films of the composition of claim 1 which were spin coated onto wafers and hot plate baked at temperatures ranging from 225° C. up to 295° C. The films were measured using a line point measurement approach for thickness and uniformity both before and after dispensing propylene glycol monomethyl ether acetate (PGMEA) onto the film. At 275° C., film retention and uniformity was reasonably good. At a temperature of 285° C. and 295° C. there was no significant variation in film thickness and uniformity between the sample before and after exposure to the PGMEA.

### Example 3

To demonstrate how control of the modulus impacts agglomeratioin, samples of matrix material were B-staged but without the inclusion of the poragen. The b-staged material was precipitated in water and vacuum dried and molded at room temperature to form circular disks having 7.9 mm diameter and about 2-4 mm thickness. The disks were put in Dynamic Mechanical Spectrometer in parallel plate geometry under an initial force of about 600-700 gm-cm. The temperature in the device was rapidly increased temperature to match hot plate temperature stated in Table 1 above. When multiple plate bakes were used above, the first temperature was maintained for about 5 to 15 minutes or until the modulus appeared flat.

For a sample mimicking the cure of sample A in Table 1 (i.e. DMS temperature was rapidly increased and then held at 400° C., the modulus dropped from a value of about 2×10⁷ dynes/cm² to a value of about 5×10⁴ dynes/cm² before substantial cure occurred and the matrix rose again to levels above 10⁷ dynes/cm²(a drop of 99%).

For a sample mimicking the cure of B in Table 1, the modulus dropped from a value of about 2×10⁷ to about 4×10⁶ dynes/cm² (a drop of 80%).

For a sample mimicking the cure of sample H in Table 1 (i.e. DMS temperature raised to 250° C. until modulus stabilized and then raised again to 285° C.) no significant modulus drop was observed. Modulus remained on the order of 2×10⁷ dynes/cm².

This demonstrates that by maintaining modulus levels or avoiding large drops in modulus, poragen agglomeration can be minimized and pore size kept low.

What is claimed is:

1. A method comprising the steps of:
(a) providing a substrate;
(b) forming a first layer which comprises a poragen material dispersed in a matrix precursor material on the substrate,
(c) curing the matrix precursor to form a gelled matrix material,
(d) solvent coating a subsequent layer over the gelled layer, and
(e) removing the poragen material from the first layer after application of the subsequent layer,
wherein the process is characterized in that the first layer does not undergo any substantial decrease in shear modulus prior to removal of the poragen.

2. A method comprising the steps of:
(a) providing a substrate;
(b) forming a first layer which comprises a poragen material dispersed in a matrix precursor material on the substrate wherein the poragen material has an average diameter of less than 50 nm,
(c) curing the matrix precursor to form a gelled matrix material,
(d) solvent coating a subsequent layer over the gelled layer, and
(e) removing the poragen material from the first layer after application of the subsequent layer to form pores in the matrix material,
(f) curing the gelled matrix material to a vitrified state
wherein the process is characterized in that the pores have an average pore size that is no more than 40% larger than the average poragen diameter.

3. The method of claim 2 wherein the average pore size is no more than 30% larger than the average poragen diameter.

4. The method of claim 2 wherein the average pore size is no more than 20% larger than the average poragen diameter.

5. The method of claim 1 wherein the modulus of the matrix precursor material does not decrease by more than 80% based on initial modulus of the matrix precursor material.

6. The method of claim 1 wherein the modulus of the matrix precursor material does not decrease by more than 50% based on initial modulus of the matrix precursor material.

7. The method of claim 1 wherein the modulus of the matrix precursor material does not decrease by more than 30% based on initial modulus of the matrix precursor material.

8. The method of claim 1 wherein the modulus of the matrix precursor material does not decrease by more than 20% based on initial modulus of the matrix precursor material.

9. The method of claim 1 wherein the modulus of the first layer does not fall below 4×10⁶ dynes/cm².

10. The method of claim 1 wherein the modulus of the first layer does not fall below 8×10⁶ dynes/cm².

11. The method of claim 1 wherein the modulus of the first layer does not fall below 1×10⁷ dynes/cm²

12. The method of claim 1 wherein the poragen is grafted to the matrix precursor.

13. The method of claim 1 wherein the poragen is grafted to the matrix precursor.

14. The method of claim 1 wherein the step of curing the matrix material to a vitrified state occurs prior to or simultaneously with the step of removing the poragen material.

15. The method of claim 2 wherein the step of curing the matrix material to a vitrified state occurs prior to or simultaneously with the step of removing the poragen material.

16. The method of claim 1 wherein the matrix precursor is an organic thermosetting material.

17. The method of claim 2 wherein the matrix precursor is an organic thermosetting material.

18. The method of claim 1 wherein the matrix precursor is a polyarylene or polyarylene ether based material that cures via Diels Alder reaction, reaction between acetylene functional groups, or some combination of those mechanisms.

19. The method of claim 2 wherein the matrix precursor is a polyarylene or polyarylene ether based material that cures via Diels Alder reaction, reaction between acetylene functional groups, or some combination of those mechanisms.

20. The method of claim 19 wherein the Diels Alder reaction is a reaction between a cycopentadienone functional group and an acetylene functional group.

21. The method of claim 1 wherein the poragen is a thermally removable polymeric material.

22. The method of claim 2 wherein the poragen is a thermally removable polymeric material.

23. The method of claim 1 wherein the step of curing to form a gelled matrix material comprises rapid heating of the coated substrate.

24. The method of claim 2 wherein the step of curing to form a gelled matrix material comprises rapid heating of the coated substrate.

25. The method of claim 23 wherein the rapid heating is performed using a hot plate.

26. The method of claim 24 wherein the rapid heating is performed using a hot plate.

27. The method of claim 26 wherein the first curing step comprises heating to an initial hot plate temperature not more than 50° C. above and not less than 75° C. below the glass transition temperature of the matrix precursor material.

28. The method of claim 27 wherein the first curing step comprises a second hot plate bake step at a temperature greater than the initial hot plate bake temperature and less than the initial hot plate bake temperature plus 150° C.

29. The method of claim 27 wherein the first curing step comprises a second hot plate bake step at a temperature which is less than the greater of 40° C. above the initial hot plate temperature or 50° C. above the original glass transition temperature of the matrix precursor.

30. The method of claim 26 wherein the first curing step comprises a first hot plate bake step at a temperature in the range of 200 to 270° C. and a final hot plate bake step at a temperature between 280 and 420° C.

31. The method of claim 26 wherein the first curing step comprises a first hot plate bake step at a temperature in the range of greater than 250° C. and less than 280° C.

32. The method of claim 31 wherein the first curing step comprises a second hot plate bake step at a temperature of at least 275° C. provided such temperature is greater than the first hot plate bake step.

33. The method of claim 32 wherein the second hot plate bake temperature is less than 300° C.

34. The method of claim 2 wherein the subsequent layer is an organic or inorganic polymeric material coated from a solvent.

35. The method of claim 2 wherein the poragen is removed by gradually increasing the coated substrate to a temperature in the range of 300 to 500° C.

36. The method of claim 35 wherein gradual increase of the temperature is performed in an oven.

37. The method of claim 2 wherein the subsequent layer is an organosilicate.

38. The method of claim 2 wherein the solvent used in coating the subsequent layer is selected from mesitylene, methyl benzoate, ethyl benzoate, dibenzylether, diglyme, triglyme, diethylene glycol ether, diethylene glycol methyl ether, dipropylene glycol methyl ether, dipropylene glycol dimethyl ether, propylene glycol methyl ether, dipropylene glycol monomethyl ether acetate, propylene carbonate, diphenyl ether, cyclohexanone, butyrolactone, ethyl 3-ethoxypropionate, N-methylpyrrolidinone, dimethylformamide, dimethylacetamide, tetrahydrofuran, dimethylpropylene urea, butyl acetate, methyl isobutyl ketone, cyclopentanone and mixtures thereof.
